(19) United States
(12) Patent Application Publication
(10) Pub. No.: US 2004/0046499 A1
(43) Pub. Date: Mar. 11, 2004

(54) Efficient light emitting device having high refractive cover layer

(76) Inventors: Nae-Man Park, Daejeon (KR); Sang-Hyeob Kim, Chungcheongnam-do (KR); Gun-Yong Sung, Daejeon (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 10/316,032

(22) Filed: Dec. 11, 2002

(30) Foreign Application Priority Data
Sep. 5, 2002 (KR) 2002-53452

(51) Int. Cl. H05B 33/00

(52) U.S. Cl. 313/509

(57) ABSTRACT

There is provided a light-emitting device that increases an emissivity in a light emission layer so as to improve luminous efficiency. The light-emitting device includes a cover layer formed by depositing a material having a high refractive index that is higher than that of the light emission layer. The light-emitting device increases a ratio of the light reflected internally into the light-emitting device to increase a light absorption in the light emission layer, thereby enhancing emissivity in the light emission layer. Therefore, the light-emitting device can enhance the efficiency of it, even when the light emission layer is made of a conventional material, and can satisfy the commercial requirement for a display that is very bright.

### BACKGROUND OF THE INVENTION

This application claims the priority of Korean Patent Application No. 2002-053452 filed on Sep. 5, 2002, which is incorporated herein in its entirety by reference.

1. Field of the Invention

The present invention relates to a light-emitting device (LED) used in a display device, and more particularly, to a light-emitting device (LED) having a high luminous efficiency by simply improving the structure of the LED.

2. Description of the Related Art

In general, a light-emitting device means a device using all sorts of light emitting mechanisms, e.g., electroluminescence (EL), photoluminescence (PL), cathodoluminescence (CL), or the like. With the advent of the information age, various kinds of displays have been developed. In particular, a display which uses EL (electroluminescence) has drawn much attention. A light-emitting device using EL is configured such that a semiconductor EL layer or an organic EL layer is included between two electrodes so as to emit light when an electric field is applied to the EL layer.

The extraction ratio, which the light incurred within the light-emitting device is extracted to the outside, relates to a critical angle θc of total internal reflection when the light emerges from a random medium having a refractive index of n, and encounters air having a refractive index of 1.0 according to Snell's law: The critical angle is given by

Sin θc=1/n (Eq. 1)

The volume of the escape cone τ of the critical angle θc is obtained by the following equation 2.

τ=½n² (Eq. 2)

From the equation 2, the ratio of the reflected light δ to the total light generated in an EL layer, which is not emitted to air but reflected into the medium, is expressed by the following equation 3.

δ=2n² (Eq. 3)

The luminous efficiency of the light emitting device relates to the equilibrium photon state occupation probability f according to a theory on blackbody radiation and is obtained by the following equation 4,

$$f = \frac{{ⅇ}^{\frac{qV}{kT}}}{exp ( E / kT ) - 1} \qquad ( Eq . 4 )$$

where V denotes an applied voltage, T denotes the temperature of the light-emitting device, and E denotes light energy. When considering the light absorption of a light-emitting device, the real photon state occupation probability f′ is related to the equilibrium photon state occupation probability f obtained using equation 4, with the following equation 5,

$${f}^{′} = \frac{{a}_{bb}}{{a}_{bb} + {a}_{pa}} f \qquad ( Eq . 5 )$$

where a_{bb} and aₚₐ are band-to-band and parasitic absorption coefficients, respectively. If a light-emitting device gets out of an unstable state and reaches the equilibrium, the real photon state occupation probability f′ finally becomes equal to the emissivity η of the light emitted from a light-emitting device.

In order to increase emissivity η of light in equilibrium state under a constant external voltage, either the light absorption coefficient a_{bb} should be increased or the light absorption coefficient aₚₐ should be decreased. In order to decrease aₚₐ, it is necessary to produce an EL layer having high quality crystallographic characteristics. There have been studies on the production of an EL layer having high quality crystallographic characteristics in terms of the material science. In order to increase a_{bb}, it is necessary to increase the absorption of the generated light in the light emission layer by increasing δ, the amount of light reflected into the light-emitting device. The ratio of light absorption is related to the refractive index of a medium as indicated by equation 3. Therefore, if the refractive index of the medium increases, the volume of the escape cone τ defined by the critical angle θc decreases according to equation 2, and the ratio of light reflected internally into the light-emitting device increases according to equation 3. Therefore, a_{bb} increases due to an increase in the light absorption ratio in the light emission layer. However, increasing the refractive index of a medium by using an EL layer having a high refractive index limits the selection of the material because it is necessary to find a medium that functions as a light-emission layer while having a high refractive index.

### SUMMARY OF THE INVENTION

It is an object of the present invention to provide a light-emitting device with high luminous efficiency while it has a light emission layer made of a commonly used material, by increasing the internal light absorption in the light emission layer through a different method from the conventional method.

According to one aspect of the present invention, there is provided a light-emitting device having a light emission layer interposed between two electrodes comprising a cover layer formed by depositing a material having a high refractive index that is higher than that of the light emission layer. Owing to the cover layer, the amount of the light reflected internally into the light-emitting device increases, and thus light absorption in the light emission layer increases.

In a preferred embodiment, the material having a high refractive index may be a polymer, a semiconductor substance, an insulator or a dielectric material, and the refractive index of the material having a high refractive index is higher than 2.0. For example, the refractive index may be higher than 2.0 and lower than or equal to 5.0. In most case, the refractive index is usually higher than 2.0 and lower than 4.0.

The thickness of the cover layer is 5×10⁻⁶-1×10⁻²cm. The cover layer may be formed by depositing one to ten layers, and, in this case, the cover layer is formed by sequentially depositing two materials having different refractive index.

The light emission layer is an organic substance or a semiconductor.

Increasing the refractive index of the medium by using an EL layer having a high refractive index limits the selection of the material because it is necessary to find a medium that functions as a light emission layer while having a high refractive index. However, according to the present invention, by a simple structural adjustment where a material having a high refractive index is added to the top surface of the light emitting device, it is possible to obtain a light-emitting device having a high luminous efficiency, even with a light emission layer having a low refractive index, without limiting the selection of the material for the light emission layer.

### BRIEF DESCRIPTION OF THE DRAWINGS

The above objects and advantages of the present invention will become more apparent by describing in detail preferred embodiments thereof with reference to the attached drawings in which:

FIG. 1 is a sectional view of a semiconductor light-emitting device according to a first embodiment of the present invention;

FIG. 2 is a sectional view of a semiconductor light-emitting device according to a second embodiment of the present invention;

FIG. 3 is a sectional view of an organic light-emitting device according to a third embodiment of the present invention; and

FIG. 4 is a sectional view of a semiconductor light-emitting device according to a fourth embodiment of the present invention.

### DETAILED DESCRIPTION OF THE INVENTION

The present invention now will be described more fully with reference to the accompanying drawings, in which preferred embodiments of the invention are shown. This invention may, however, be embodied in many different forms and should not be construed as being limited to the embodiments set forth herein; rather, these embodiments are provided so that this disclosure will be thorough and complete and will fully convey the concepts of the invention to those skilled in the art.

A cover layer of the present invention can be deposited on a top surface of the light-emitting devices of various structures, and the following embodiments are provided to explain such light-emitting devices. Accordingly, differences in the structure and the detailed selection of materials for the light-emitting device other than the cover layer, represent simple structural changes of the technical spirit of the present invention.

### First embodiment

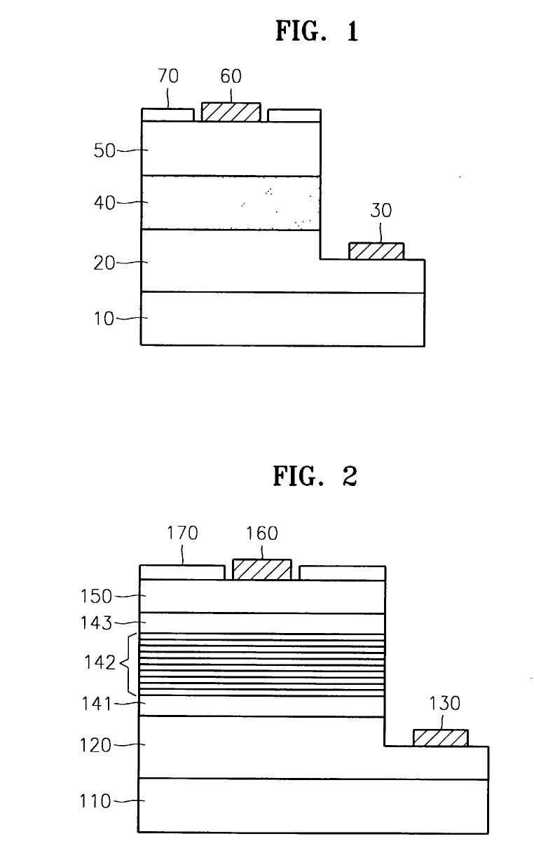

FIG. 1 is a cross-sectional view of a semiconductor light-emitting device according to a first embodiment of the present invention.

Referring to FIG. 1, in the semiconductor light-emitting device according to the present invention, an n-contact layer 20, a semiconductor light emitting layer 40, a p-contact layer 50, and a p-electrode 60 are sequentially deposited on a substrate 10. The n-contact layer 20 has a part of its surface exposed, and an n-electrode 30 is formed thereon. Here, the n-contact layer 20, the light emitting layer 40, and the p-contact layer 50 altogether comprises a light emission layer in a broad sense. A cover layer 70 is additionally formed on the p-contact layer 50 beside the p-electrode 60. The cover layer 70 is formed by depositing a material having a high refractive index, one that is higher than that of the light emission layer in a broad sense, and the thickness of the cover layer 70 may be, but is not limited to, 5×10⁻⁶˜1×10⁻²cm.

Here, the substrate 10 is a commonly used sapphire substrate, the n-contact layer 20 is formed of GaN doped with Si, and the light emission layer 40 is formed of InGaN doped with both Si and Zn thereby may have a double hetero (DH) structure. That is, the light emission layer 40 causes light emission through a D-A (Donor-Acceptor) recombination of impurities doped in an active layer. In addition, the p-contact layer 50 is formed of GaN doped with Mg. Since a current cannot flow in the substrate 10 formed of sapphire, the substrate 10 is configured so that the n-contact layer 20 is exposed by dry etching so as to form the n-electrode 30. The n-electrode 30 may be a Ti/Al electrode, and the p-electrode 60 may be Ni/Au electrode.

Preferably, the cover layer 70 is formed by depositing a material having a high refractive index than the uppermost layer of the light emission layer in a broad sense. Thus, in this embodiment the cover layer 70 is formed of a material having higher refractive index than the p-contact layer 50. In this embodiment, a case where the n-contact layer 20, the light emitting layer 40, and the p-contact layer 50 altogether comprises a light emission layer in a broad sense is described. However, the semiconductor light-emitting device can be fabricated with only the light emitting layer 40. In such case, of course, the cover layer 70 is formed of a material having a high refractive index than that of the light emitting layer 40.

The cover layer 70 can be typically formed by applying a polymer substance having a high refractive index and also by a semiconductor substance, an insulating substance, or a dielectric substance having a high refractive index. Since a process of producing the cover layer by the polymer substance having the high refractive index is simpler than other process using other semiconductors or insulating materials, the light-emitting device having a high luminous efficiency can be easily manufactured. More specifically, the process includes manufacturing a slurry having the polymer substance of a desired refractive index, applying the slurry to the surface of the light-emitting device by a dip coating or a spin coating method, and then baking the light-emitting device to ensure its stability and reliability.

When GaN is used for the p-contact layer 50, the refractive index of the cover layer 70 should be higher than 2.5, which is the refractive index of GaN. When the insulating or dielectric substance is used for the cover layer 70, one of PbO, SiC, TiO₂, and PbS can be used. Their refractive indices are 2.61, 2.68, 2.71, and. 3.91, respectively. If the p-contact layer 50 consists of a substance having a lower refractive index than that of GaN, SnO₂, ZrO₂, or CaTiO₃ can be used. The refractive indices are 1.995, 2.205, and 2.355, respectively. The methods for applying the substances to the surface of the light-emitting device include vacuum evaporation such as an electron beam vacuum evaporation or a thermal evaporation or the like. If a commercialised evaporation starting substance is not available, it is possible to manufacture a desired evaporation starting substance by a sol-gel process or high temperature sintering. Alternatively, sputtering or chemical vapour deposition can be used. In general, the refractive index of the light emission layer in a broad sense is lower than 2.0, and so a candidate material for the cover layer 70 is required to have a high refractive index that is higher than 2.0.

Meanwhile, when the semiconductor substance is formed with the cover layer 70, GaP having a refractive index of 3.4 can be used. Depositing such semiconductor substance on the surface of the light-emitting device can be performed by metal-organic chemical vapor deposition.

If the cover layer 70 having a high refractive index is deposited, the amount of the light reflected internally into the light-emitting device increases, and thus the light absorption of the light in energy gap of the light emission layer 40 increases. The increase in the light absorption means an increase in the light absorption coefficient a_{bb} and an increase in f′ as shown in equation 5. If the light-emitting device gets out of an initial instability and reaches the equilibrium, f′ finally becomes equal to the emissivity η. Therefore, the emissivity increases.

For example, if the refractive index of the p-contact layer 50 is 1.5 and the refractive index of the cover layer 70 is 3, (2×3²)/(2×1.5²)=4 times (300%) of the luminous efficiency can be induced by equation 3. Considering that improved efficiency is achieved by a simple change of additionally depositing one cover layer 70, it is an outstanding improvement. Accordingly, it is possible to obtain a high luminous efficiency of the light-emitting device by a simple method of additionally forming the cover layer without a need for changing the material for the light emission layer.

### Second embodiment

FIG. 2 is a sectional view of a semiconductor light-emitting device according to a second embodiment of the present invention.

The semiconductor light-emitting device illustrated in FIG. 2 employs a quantum well structure for a light-emitting layer 142. Referring to FIG. 2, an n-contact layer 120 is formed on a substrate 110, an n-electrode 130 is formed on the n-contact layer 120, and a light emitting layer 142 having the quantum well structure is formed on the n-contact layer 120. A p-contact layer 150 is formed on the light-emitting layer 142 and the p-electrode 160 is formed on the p-contact layer 150. The cover layer 170 having a high refractive index is formed on the p-contact layer 150 beside the p-electrode 160.

The n-contact layer 120 is formed of GaN doped with Si, and the p-contact layer 150 is formed of GaN doped with Mg. The n-electrode 130 can be Ti/Al electrode, and the p-electrode 160 can be a Ni/Au electrode. The light emission layer 142, which can be an InGaN having the quantum well structure, is surrounded by a GaN barrier or an InGaN barrier and then, is surrounded by an n-AlGaN clad layer 141 doped with Si and a p-AlGaN clad layer 143 doped with Mg. However, the n-clad layer 141 and the p-clad layer 143 can be omitted. It is possible to diversify the quantum well structure of the light emission layer 142 from one to pluralities according to a system or a necessary characteristic.

The cover layer 170 is formed by depositing a material having a high refractive index that is higher than that of the p-contact layer 150, and the thickness of the cover layer 170 can be 5×10⁻⁶-1×10⁻²cm. In addition, the material having a high refractive index can be a polymer substance, a semiconductor substance, an insulating substance or a dielectric substance, and its refractive index is preferably higher than 2.5. The cover layer 70 as described in the first embodiment can constitute the cover layer 170 of the second embodiment.

If the cover layer 170 is formed in the light-emitting device having the quantum well structure, the FWHM (full width half maximum) of an EL spectrum increases compared to the FWHM of the DH structure shown in FIG. 1. Thus colors become more vivid due to the quantum well structure, and the luminous efficiency is improved due to an increase in the light absorption of the light emission layer.

### Third embodiment

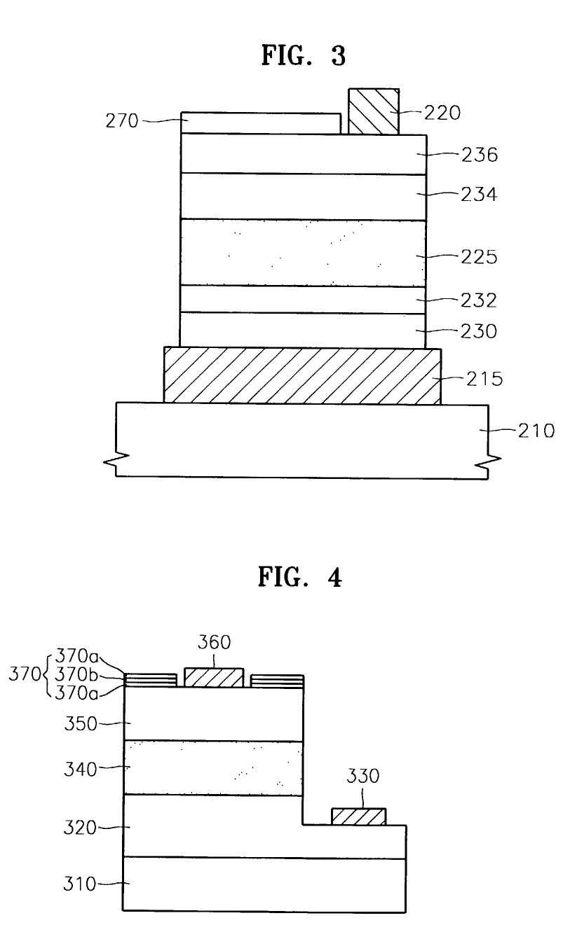

FIG. 3 is a sectional view of an organic light-emitting device according to a third embodiment of the present invention.

Referring to FIG. 3, an anode electrode 215 and a cathode electrode 220 are disposed with a predetermined distance between them on a substrate 210. Light materials such as plastic or glass can be used as the substrate 210. The anode electrode 215 can be formed by a transparent dielectric layer such as an ITO (indium tin oxide) layer. Also, the anode electrode 215 can be formed by mixing indium oxide and tin oxide, at an appropriate ratio that depend on the desired transmissivity or conductivity, through sputtering. In addition, the cathode electrode 220 can be formed of a metal layer of, for example, Al, Mg/Ag or Li/Al.

Between the anode electrode 215 and the cathode electrode 220, an organic light emission layer 225 is interposed, from which the light is emitted when a voltage or a current is applied to the anode electrode 215 and the cathode electrode 220. Forming a buffer layer (not shown) between the anode electrode 215 and the light emission layer 225 by coating a conducting substance with a thickness of 30 nm can improve interfacial characteristics. For the buffer layer, polythiophene or polyaniline can be used.

The anode electrode 215 provides holes to the light emission layer 225, and the cathode electrode 220 supplies electron to the light emission layer 225. A hole and an electron supplied to the light emission layer 225 combine in the light emission layer 225 to form an exciton, and the exciton goes down to a ground state and emits a light corresponding band gap of the light emission layer 225. Therefore, a color of the emitted light changes according to the band gap of the light emission layer 225.

For example, if a green light is desired, the light emission layer 225 includes a tris (8-hydroxyquinolinato aluminum)). If a blue light is desired, the light emission layer 225 includes 4-4′-Bis (2,2-diphenylethen-1-yl) biphenyl (DPVBi). The light emission layer 225 can be formed by filtering a light emitting polymer fluid, manufactured by dissolving the polymer into a solvent, with a filter of about 0.2 mm and then by spin coating the filtered fluid to a thickness of 100 nm. The light emission layer 225 is typically dried in a vacuum oven maintained to have a temperature of about 100° C. for about two hours.

In order to enhance the efficiency of the organic light-emitting device, a hole injection layer 230 and a hole transport layer 232 can be sequentially formed between the anode electrode 215 and the light emissiori layer 225. Between the light emitting layer 225 and the cathode electrode 220, an electron transport layer 234 and an electron injection layer 236 can be sequentially formed. Here, the hole, injection layer 230, the hole transport layer 232, the electron transport layer 234, and the electron injection layer 236 are formed with an organic thin film. For example, for the hole transport layer 232, an organic substance including N, N′-diphenyl-N, N′-bis(3-methylphenyl)-1 and 1′-diamin (TPD) can be used, which are all organic thin films and can be deposited using a vacuum evaporation and polymerization, sputtering, thermal evaporation, or electron beam evaporation.

The substrate 210 can be formed with polycarbonate, polyimide, polyethyleneterephthalate, or a polyethylenenaphthalate in addition to glass. Further, the anode electrode 215 can be formed using zinc oxide.

Here, the organic light emission layer 225, the hole injection layer 230, the hole transport layer 232, the electron transport layer 234, and the electron injection layer 236 are altogether comprises a light emission layer in a broad sense. A cover layer 270 is formed on the electron injection layer 236 by depositing a material having a high refractive index. The index of the material is higher than that of the light emission layer in a broad sense. Preferably, the cover layer 270 is formed by depositing a material having a higher refractive index than the uppermost layer of the light emission layer in a broad sense. Thus, in this embodiment the cover layer 270 is formed of a material having higher refractive index than the electron injection layer 236. However, in case of the organic light-emitting device being fabricated with only the organic light emission layer 225, the cover layer 270 is formed of a material having a high refractive index than that of the organic light emission layer 225.

If a cover layer 270 having a high refractive index is formed on the light-emitting device having such structure, the light absorption in the light emission layer 225 increases, and the luminous efficiency is improved. The material having the high refractive index can be a polymer, a semiconductor substance, an insulating substance or a dielectric substance and the refractive index is preferably higher than that of the light emission layer. Other descriptions as to the cover layer 270 which are not described here can be constituted by the cover layer 70 in the first embodiment.

### Fourth embodiment

FIG. 4 is a sectional view of a semiconductor light emitting device semiconductor according to a fourth embodiment of the present invention.

Referring to FIG. 4, except for a cover layer 370 of the light-emitting device according to the fourth embodiment, all other parts are similar to the first embodiment. Namely, an n-contact layer 320, a semiconductor light emission layer 340, a p-contact layer 350, and a p-electrode 360 are sequentially formed on a substrate 310. An n-electrode 330 is formed on an exposed portion of a surface of the n-contact layer 320.

The cover layer 370 additionally formed on the p-contact layer 350, separately from the p-electrode 360, is formed by depositing at least two layers of materials having a high refractive index that is higher than that of the p-contact layer 350. Here, the cover layer 370 can be formed by sequentially depositing layers of materials having different high refractive indices in turn. Reference numeral 370a denotes a material having a high refractive index. Reference numeral 370b denotes a material having a high refractive index that is lower than that of 370a but higher than that of the p-contact layer 350. In this case, each layer is not limited by the thickness.

As described above, if the cover layer 370 is formed with a plurality of layers, the light reflected into the light-emitting device and the light absorption in the light emission layer can increase, and thus the luminous efficiency is greatly improved.

According to the present invention, light absorption in a light emission layer increases due to a cover layer having a high refractive index such that the efficiency of the light-emitting device in the equilibrium is enhanced. In addition, the increase in the internal absorption of the light emitted in the light emission layer in the energy gap of the light emission layer can improve the efficiency of the light-emitting device in the equilibrium. That is, it is possible to enhance the efficiency of the light-emitting device in the equilibrium simply by adding a step of depositing a material having a high refractive index to a conventional method of fabricating the light-emitting device, while still using a conventional material for the light emission layer, by increasing a_{bb} of equation 5. Therefore, the cover layer can be effectively and practically used, as a means for improving the luminous efficiency. According to the present invention, the commercial requirement of a display that is very bright can be met through a simple structural adjustment.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A light-emitting device having a light emission layer interposed between two electrodes, the light emitting device comprising:
A cover layer formed by depositing a material having a high refractive index that is higher than that of the light emission layer by increasing the ratio of the light reflected internally into the light-emitting device to increase light absorption in the light emission layer to thereby enhance an emissivity in the light emission layer.

2. The light-emitting device of claim 1, wherein the refractive index of the material having a high refractive index is higher than 2.0.

3. The light-emitting device of claim 1, wherein the material having the high refractive index is a polymer.

4. The light-emitting device of claim 1, wherein the material having the high refractive index is a semiconductor substance.

5. The light-emitting device of claim 1, wherein the material having the high refractive index is an insulating or dielectric substance.

6. The light-emitting device of claim 1, wherein the thickness of the cover layer is 5×10⁻⁶-1×10⁻²cm.

7. The light-emitting device of claim 1, wherein the cover layer is configured to have a deposition structure of 1-10 layers.

8. The light-emitting device of claim 7, wherein the cover layer is formed by sequentially depositing two materials having different high refractive index.

9. The light-emitting device of claim 1, wherein the light emission layer is a semiconductor.

10. The light-emitting device of claim 1, wherein the light emission layer is an organic substance.
